(19) United States
(12) Patent Application Publication
(10) Pub. No.: US 2010/0288976 A1
(43) Pub. Date: Nov. 18, 2010

(54) Method And Plant For Producing A Chilled Compressed Synthesis Gas

(75) Inventor: Benoit Davidian, Saint Maur Des Fosses (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Exploitation Des Procedes Georges Claude, Paris (FR)

(21) Appl. No.: 12/743,484

(22) PCT Filed: Nov. 24, 2008
(86) PCT No.: PCT/FR08/52114

§ 371 Date: May 18, 2010

(30) Foreign Application Priority Data
Nov. 26, 2007 (FR) 0759299

(51) Int. Cl. C01B 3/02; F25B 29/00

(52) U.S. Cl. 252/373; 422/208

(57) ABSTRACT

A method and a plant for producing a cooled compressed syngas is presented.

The present invention relates to a method and a plant for producing a cooled compressed syngas.

The generation of an H₂/CO syngas takes place by steam methane reforming (SMR) (methane possibly being replaced with other hydrocarbon feeds such as naphtha, fuel oil, methanol, etc.) or by partial oxidation (POX, ATR). The process takes place at very high temperatures (800-1300° C.)

To prevent damage to the metal equipment, it is necessary, at the reactor outlet and before the crude syngas is subsequently treated (shift, purification, PSA, etc.), to suddenly cool it in order to prevent said syngas from spending too long in the temperature zone where “carbon dusting” occurs, i.e. a zone between 400 and 800° C. since at these temperatures the syngas corrodes the metal equipment.

One known solution employed consists in cooling the very hot syngas by passing it into a boiler thus enabling its heat to be recovered in order to produce steam. This boiler is used to quench the syngas, i.e. to rapidly cool it.

However, the overall syngas process merely produces excess steam compared to its consumption and it is therefore necessary, to utilize the syngas heat, to find a customer interested in using this steam.

There is therefore a need to utilize the syngas heat recovered when quenching it for a purpose other than steam production.

One object of the present invention is therefore to provide a method of cooling the syngas with heat recovery not dedicated to steam production, or more generally to the production of one or more hot fluids.

Another object of the present invention is to increase the pressure of the syngas relative to the pressure after the reforming operation.

The invention proposes to do this by quenching the very hot syngas offered by the reforming reactor by direct injection of liquid water using a thermokinetic compressor which makes it possible, in a single step, to compress the syngas while suddenly cooling it, thereby avoiding “metal dusting”.

The increase in syngas pressure thus achieved may be put to good use in various ways:
for a given syngas pressure at the reactor outlet, it is beneficial to have a higher downstream pressure, which may be advantageous in a PSA treatment (better efficiency at a higher pressure) and in possible H₂ compression operations especially up to the pressure of the network (reduction in compression energy);
for a given downstream pressure, it is possible to use a lower pressure in the syngas generation reactor, thereby making it possible for example to reduce the amount of CH₄ contained in the syngas (increase in conversion yield) or else to reduce the energy required to compress the hydrocarbon feed and optionally the O₂ in the case of POX and ATR. If it is decided to lower the pressure in the reformer (relative to a conventional pressure level), there is a very important additional benefit whereby it is possible to reduce the mechanical stresses on the reforming tubes in the furnace, enabling the lifetime of the tubes to be extended very significantly.

Thus, two particularly advantageous simultaneous effects are combined:
the syngas is quenched; and
the syngas pressure is increased.

The thermokinetic compressor enables the thermal energy contained in the syngas coming from the generation step to be utilized. This energy is in fact consumed by the syngas itself.

A thermokinetic compressor compresses a gas by accelerating it up to a high velocity, preferably above the velocity of sound (typically of the order of 300 m/s), by cooling it, for example by direct contact with water droplets, and then by slowing it.

The cooling may take place before, during or after the acceleration.

The syngas may be accelerated by passing it through a throat, for example a de Laval nozzle. Likewise, to decelerate the syngas it is passed through a second throat, for example a de Laval nozzle.

The energy required by the thermokinetic compressor is provided by the syngas. The preferred coolant is water, which is removed and/or used subsequently at the same time as the water already present (in steam form) in the syngas after the reforming operation.

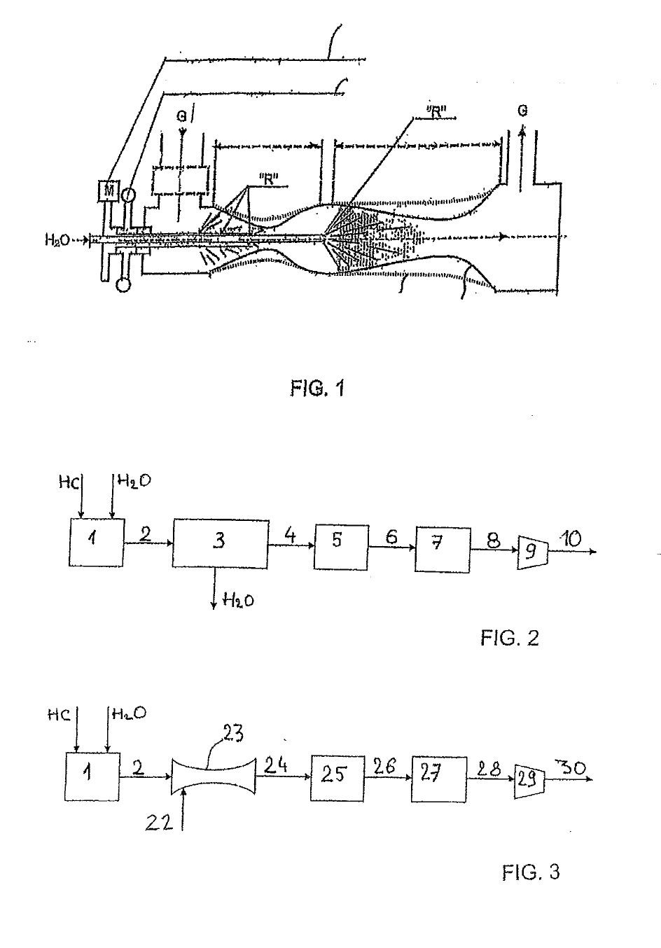

An example of a thermokinetic compressor is described in patent application FR-A-2805008. The principle is based on cooling a gas by the vaporization of fine water droplets, followed by compression of said gas, using an arrangement of convergent and divergent nozzles. FIG. 1 shows one model of a thermokinetic compressor based on this concept.

The first subject of the invention relates to a method of producing a syngas from a hydrocarbon feed, comprising at least the following steps: a hot crude syngas is generated at a temperature T2 and a pressure P2; and the syngas is rapidly cooled so as to produce a cooled syngas at a temperature T24, in which the step of cooling the hot crude syngas is carried out in at least one thermokinetic compressor which simultaneously cools and compresses the hot crude syngas in order to produce the syngas cooled to the temperature T24 and compressed to a pressure P24 using a coolant.

Preferably, the coolant is liquid water.

Advantageously, the hot crude syngas is generated at a temperature T2 above 800° C.

Also advantageously, the cooled syngas has a maximum temperature of 400° C.

The second subject of the invention relates to a syngas production plant comprising at least one reactor for generating a hot crude syngas, a thermokinetic compressor, means for feeding the reactor, means for sending the crude hot syngas from the reactor to the thermokinetic compressor, means for feeding the thermokinetic compressor 23 with coolant 22 and means for discharging the cooled compressed syngas 24.

The invention will now be described in greater detail in conjunction with FIGS. 2 and 3,

FIG. 2 representing a base diagram of a method of producing syngas for the eventual production of hydrogen and

FIG. 3 representing a method of producing syngas for the eventual production of hydrogen according to the invention.

In FIG. 2, according to the prior art, a steam methane reformer 1 is fed with light hydrocarbons HC and with steam in order to produce a syngas 2 essentially containing H₂, CO and CO₂ at a pressure P2 and a temperature T2. The syngas 2 produced is then quenched by passing it through a boiler 3 where its heat is suddenly transferred to boiler water in order to produce superheated steam and a syngas 4 cooled at a pressure P4 and a temperature T4. The syngas 4 is introduced into a shift reactor 5 in the presence of water (not shown) to produce a stream of impure hydrogen 6 at a pressure P6. The impure hydrogen 6 is then introduced into a PSA unit 7 where it is purified, so as to deliver purified hydrogen 8 at a pressure P8. Finally, the hydrogen 8 is compressed in a compressor 9 so as to deliver compressed hydrogen 10 at a pressure P10 above the pressure of the network 11 for which it is intended.

In FIG. 3, according to the invention, a steam methane reformer 1 is fed with light hydrocarbons HC and with steam in order to produce a syngas 2 essentially containing H₂, CO and CO₂ at a pressure P2 and a temperature T2. The syngas 2 produced then passes into the thermokinetic compressor 23 where it is compressed and suddenly cooled (quenched) by direct injection of liquid water 22. This therefore produces a syngas 24 cooled to a temperature T24, compressed to a pressure P24 and having a water content increased by the amount of cooling water injected. The syngas 24 is introduced into a shift reactor 25 in the presence of water (not shown) in order to produce a stream of impure hydrogen 26 at a pressure P26. The impure hydrogen 26 is then introduced into a PSA unit 27 where it is purified in order to deliver purified hydrogen 28 at a pressure P28. Finally, the hydrogen 28 is compressed, where necessary in a compressor 29, so as to deliver compressed hydrogen 30 at a pressure P30 above the pressure of the network 31 for which it is intended.

Passing the syngas 22 through the thermokinetic compressor 23, enabling the downstream process gas pressure to be increased, offers, among other advantages:
better efficiency of the PSA treatment;
reduction in the compression energy needed to bring the hydrogen up to the pressure of the network;
possibility of lowering the reforming pressure (relative to a conventional reforming pressure level), making it possible, thanks to the compression achieved in the thermokinetic compressor, to obtain a conventional downstream syngas pressure thereby improving the CH₄ conversion efficiency and reducing the mechanical stresses on the reforming tubes, which therefore have a longer lifetime.

Both basic diagrams, namely FIG. 2 and FIG. 3, have been given as steam methane reforming (SMR) reactors but they may be extended to partial oxidation (POX) reactors, to autothermal reforming (ATR) reactors, to methanol reformers, etc.

1-5. (canceled)

6. A method of producing a syngas from a hydrocarbon feed, comprising:
a) generating a hot crude syngas at a temperature T2 and a pressure P2; and
b) coiling the syngas rapidly to produce a cooled syngas at a temperature T24, wherein the step of cooling the syngas is carried out in at least one thermokinetic compressor which simultaneously cools and compresses the syngas in order to produce the syngas cooled to the temperature T24 and compressed to a pressure P24 using a coolant.

7. The method of claim 6, in which the coolant is water.

8. The method of claim 6, in which the crude syngas is generated at a temperature T2 above 800° C.

9. The method of claim 6, wherein the cooled compressed syngas has a maximum temperature of 400° C.

10. A syngas production plant comprising:
a) at least one reactor for generating a crude syngas,
b) a thermokinetic compressor,
c) means for feeding the reactor,
d) means for sending the syngas from the reactor to the thermokinetic compressor,
e) means for feeding the thermokinetic compressor with coolant, and
f) means for discharging the cooled compressed syngas.
